(19) United States
(12) Patent Application Publication
(10) Pub. No.: US 2025/0371566 A1
(43) Pub. Date: Dec. 4, 2025

(54) INFORMATION PROCESSOR, PRICE DETERMINATION SYSTEM, DEMAND PREDICTION METHOD, AND PRICE DETERMINATION METHOD

(71) Applicants: Forcia, Inc., Tokyo (JP); Kyoto University, Kyoto (JP)

(72) Inventors: Ken UMENO, Kyoto (JP); Masaru SHINTANI, Tokyo (JP)

(73) Assignees: Forcia, Inc., Tokyo (JP); Kyoto University, Kyoto (JP)

(21) Appl. No.: 19/300,079

(22) Filed: Aug. 14, 2025

Related U.S. Application Data
(63) Continuation-in-part of application No. 18/374,232, filed on Sep. 28, 2023.

(30) Foreign Application Priority Data
Sep. 29, 2022 (JP) 2022-156164

(51) Int. Cl. G06Q 30/0202; G06Q 30/0201

(52) U.S. Cl. CPC G06Q 30/0202; G06Q 30/0206

(57) ABSTRACT

A demand prediction device derives a first exponential function representing the time-series transition of the number of bookings until a service provision time point for a first customer group based on booking transitions up to a first time point t1. A second exponential function is similarly derived for a second customer group based on booking transitions up to a second time point t2 different from t1. The device generates information supporting a service provider based on the predicted time-series transitions for the first and second customer groups. A time constant is compared with at least one threshold value to determine a system response, which triggers an adjustment to one or more operational parameters, including modifying inventory levels, adjusting reservation or scheduling limits, reallocating staffing or system resources, or updating pricing or promotional parameters. This enables dynamic demand prediction and responsive operational optimization for service provision.

### BACKGROUND

### 1. Field

The present disclosure relates to a data processing technology and particularly to an information processor, a price determination system, a demand prediction method, and a price determination method.

### 2. Description of the Related Art

The inventors of the present invention have proposed a technology for estimating the transition of the number of service bookings in a time series by applying the exponentiality of the customers' booking tendency for services provided by a given entity (e.g., accommodation facilities, etc.) (see, for example, Patent Literature 1). [Patent Literature 1] Japanese Patent Application Publication No. 2021-33718

### SUMMARY

The inventors of the present invention have come to realize that the slope of an exponential function that indicates the booking tendency of customers does not represent one slope for each unit of a service providing entity and varies according to the attributes of the customers, and have come up with a technology for improving the accuracy of estimating the number of bookings for services.

In this background, one of the purposes of the present disclosure is to provide a technology for improving the accuracy of estimating the transition of the number of bookings for services.

An information processor according to one embodiment of the present disclosure includes: an acquisition unit that acquires time-series transition of the number of bookings up to a time point t1 prior to a service provision time point for a first customer group in an entity providing a predetermined service and acquires time-series transition of the number of bookings up to a time point t2 prior to a service provision time point for a second customer group different from the first customer group; a derivation unit that derives a first exponential function indicating the time-series transition of the number of bookings up to the service provision time point for the first customer group based on the transition of the number of bookings up to the time point t1 for the first customer group and derives a second exponential function indicating the time-series transition of the number of bookings up to the service provision time point for the second customer group based on the transition of the number of bookings up to the time point t2 for the second customer group; and a generation unit that generates information for supporting the entity based on the time-series transition of the number of bookings up to an analysis target time point for the first customer group indicated by the first exponential function and the time-series transition of the number of bookings up to the analysis target time point for the second customer group indicated by the second exponential function.

Another embodiment of the present disclosure relates to a price determination system. This price determination system includes: an acquisition unit that acquires time-series transition of the number of bookings up to a time point t1 prior to a service provision time point for a first customer group in an entity providing a predetermined service and acquires time-series transition of the number of bookings up to a time point t2 prior to a service provision time point for a second customer group different from the first customer group; a derivation unit that derives a first exponential function indicating the time-series transition of the number of bookings up to the service provision time point for the first customer group based on the transition of the number of bookings up to the time point t1 for the first customer group and derives a second exponential function indicating the time-series transition of the number of bookings up to the service provision time point for the second customer group based on the transition of the number of bookings up to the time point t2 for the second customer group; and a price determination unit that determines the price for the service based on the time-series transition of the number of bookings up to an analysis target time point for the first customer group indicated by the first exponential function and the time-series transition of the number of bookings up to the analysis target time point for the second customer group indicated by the second exponential function.

Still another embodiment of the present disclosure relates to a demand prediction method. This computer-implemented method includes: acquiring time-series transition of the number of bookings up to a time point t1 prior to a service provision time point for a first customer group in an entity providing a predetermined service and acquiring time-series transition of the number of bookings up to a time point t2 prior to a service provision time point for a second customer group different from the first customer group; deriving a first exponential function indicating the time-series transition of the number of bookings up to the service provision time point for the first customer group based on the transition of the number of bookings up to the time point t1 for the first customer group and deriving a second exponential function indicating the time-series transition of the number of bookings up to the service provision time point for the second customer group based on the transition of the number of bookings up to the time point t2 for the second customer group; and generating information for supporting the entity based on the time-series transition of the number of bookings up to an analysis target time point for the first customer group indicated by the first exponential function and the time-series transition of the number of bookings up to the analysis target time point for the second customer group indicated by the second exponential function.

Still another embodiment of the present disclosure relates to a price determination method. This computer-implemented method includes: acquiring time-series transition of the number of bookings up to a time point t1 prior to a service provision time point for a first customer group in an entity providing a predetermined service and acquiring time-series transition of the number of bookings up to a time point t2 prior to a service provision time point for a second customer group different from the first customer group; deriving a first exponential function indicating the time-series transition of the number of bookings up to the service provision time point for the first customer group based on the transition of the number of bookings up to the time point t1 for the first customer group and deriving a second exponential function indicating the time-series transition of the number of bookings up to the service provision time point for the second customer group based on the transition of the number of bookings up to the time point t2 for the second customer group; and determining the price for the service based on the time-series transition of the number of bookings up to an analysis target time point for the first customer group indicated by the first exponential function and the time-series transition of the number of bookings up to the analysis target time point for the second customer group indicated by the second exponential function.

Still another embodiment of the present disclosure relates to a system and method for dynamically adjusting operational parameters based on time constant analysis of customer data. Historical transaction, reservation, and behavioral data are collected and processed to compute a time constant characterizing system responsiveness. The time constant is compared to at least one threshold to determine a system response, which triggers adjustments to operational parameters such as inventory levels, reservation limits, staffing allocations, or pricing strategies. This process enables real-time monitoring and optimization of resource utilization and service efficiency.

Optional combinations of the aforementioned constituting elements, and implementations of the disclosure in the form of computer programs, recording mediums readably recording computer programs, etc., may also be practiced as additional modes of the present disclosure.

### BRIEF DESCRIPTION OF THE DRAWINGS

Embodiments will now be described, by way of example only, with reference to the accompanying drawings that are meant to be exemplary, not limiting, and wherein like elements are numbered alike in several FIGS., in which:

FIG. 1 is a diagram showing the results of curve fitting of actual data;

FIG. 2 is a diagram schematically showing a booking curve;

FIG. 3 is a diagram showing a box-and-whisker diagram showing the booking status of a beauty salon;

FIG. 4 is a diagram showing the transition of the number of bookings at the beauty salon;

FIG. 5 is a diagram showing the configuration of a communication system according to the first embodiment;

FIG. 6 is a block diagram showing functional blocks of a demand prediction device according to the first embodiment;

FIG. 7 is a diagram showing an example of a booking curve for a first customer group;

FIG. 8 is a diagram showing an example of a booking curve for a second customer group;

FIG. 9 is a diagram showing an example of a total booking curve;

FIG. 10 is a diagram showing the configuration of a price determination system according to the second embodiment;

FIG. 11 is a block diagram showing functional blocks of a demand prediction device according to the second embodiment;

FIG. 12 is a block diagram showing functional blocks of a price determination device according to the second embodiment; and

FIG. 13 is a flow diagram showing am exemplary process of performing system parameter adjustment based on the time constant analysis derived from customer data.

### DETAILED DESCRIPTION OF THE EMBODIMENTS

The invention will now be described by reference to the preferred embodiments. This does not intend to limit the scope of the present invention, but to exemplify the invention.

Hereinafter, the technology according to the present disclosure will be described based on a preferred embodiment with reference to the figures. The embodiments do not limit the invention and are shown for illustrative purposes, and not all the features described in the embodiments and combinations thereof are necessarily essential to the invention. The same or equivalent constituting elements, members, and processes illustrated in each drawing shall be denoted by the same reference numerals, and duplicative explanations will be omitted appropriately. Terms like “first”, “second”, etc., used in the specification and the claims do not indicate an order or importance by any means unless specified otherwise and are used to distinguish a certain feature from the others.

Base Technology

An explanation will be given regarding a demand prediction algorithm as a base technology. First, definitions are given for the number of bookings and the number of cancellations. In the embodiment, it is assumed that the number of bookings X(t) and the number of cancellations Y(t) for a given day at an accommodation facility behave according to the following function.

$$\begin{matrix}X ( t ) = A {ϕ}_{X} ( t ) \\ Y ( t ) = B {ϕ}_{Y} ( t )\end{matrix} \qquad [ Equation 1 ]$$

Note that the following is established: A>B>0. Further, t is a value in units of days indicating the number of days before an accommodation date, in other words, the date of service provision. Also, φ_{X}(t) and φ_{Y}(t) are assumed to satisfy the following.

$$\begin{matrix}{ϕ}_{X} ( 0 ) = 1 , {ϕ}_{Y} ( 0 ) = 1 , \\ {lim}_{t \to ∞} {ϕ}_{X} ( t ) = 0 , {lim}_{t \to ∞} {ϕ}_{Y} ( t ) = 0\end{matrix} \qquad [ Equation 2 ]$$

That is, the following equations are established: X(0)=A, X(∞)=0; Y(0)=B; and Y(∞)=0. The following is placed as a hypothesis in this case.

It is assumed that for any equation 0≤t₁<t₂, the following equation holds:

$$φ ( {t}_{2} ) = φ ( {t}_{1} ) φ ( {t}_{2} - {t}_{1} ) \qquad Expression 1$$

An intuitive understanding is given for Expression 1. Given an interval ε and a date α, Expression 1 has the following properties.

$$φ ( α ) = φ ( 0 ) φ ( α - 0 ) = φ ( α )$$

$$φ ( α + ε ) = φ ( α ) φ ( ε )$$

In other words, regardless of the value at the time of day α, the value after ε days (or ε days before) has the property of decreasing or increasing by a certain percentage from the value at the time of day α.

This property means self-proportionality, as seen in the nature of the half-life of atoms in nature, i.e., the change in the number of observations is proportional to the number of observations at that point in time. In other words, the booking behavior of people is regarded as a natural phenomenon, and it is assumed that the number of bookings decreases day by day as the date goes backward from the deadline, e.g., in proportion to the distance from the deadline. Note that the deadline is the date for which the booking is made, in other words, the date of service provision.

If the above definitions and hypotheses are placed for the number of bookings and the number of cancellations, φX(t) and φY(t) can be expressed explicitly.

$$\begin{matrix}{ϕ}_{X} ( t ) = exp ( - \frac{t}{{τ}_{X}} ) \\ {ϕ}_{Y} ( t ) = exp ( - \frac{t}{{τ}_{Y}} )\end{matrix} \qquad [ Equation 3 ]$$

Note that τ_{X} and τ_{Y} are positive time constants, in other words, constant parameters that govern the change in the number of bookings and the number of cancellations. If the service provider is an accommodation facility, τ_{X} and τ_{Y} can be considered to be lead times and are constants that are based on the time of an increase in the number of bookings and the number of cancellations.

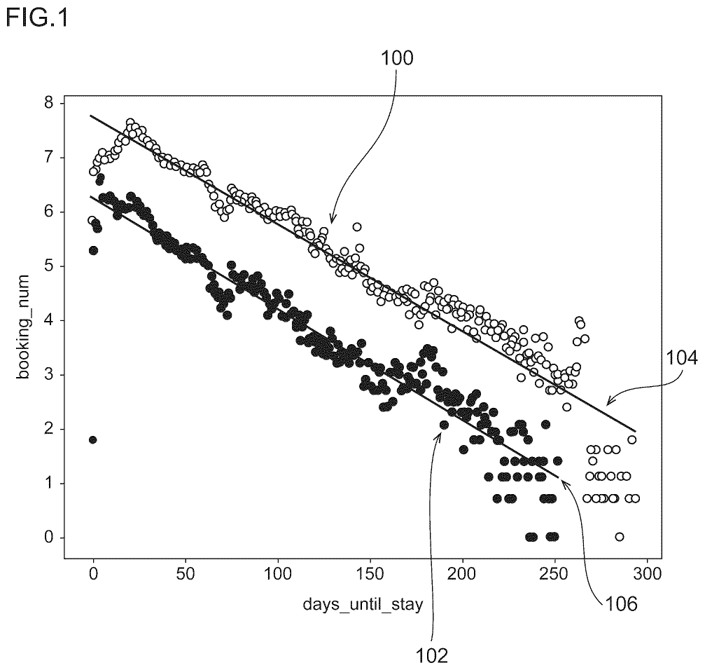

FIG. 1 shows the results of curve fitting of the actual data. The horizontal axis in FIG. 1 shows t above. That is, the axis shows the date on which the booking was made, meaning the number of days before the accommodation date, for an accommodation facility.

The vertical axis in FIG. 1 shows the number of bookings or cancellations on a logarithmic scale. A point 100 is the actual data indicating the number of bookings at a certain time point t. A point 102 is the actual data indicating the number of cancellations at the certain time point t. A booking curve 104 is a curve that approximates the transition of the point 100, and a cancellation curve 106 is a curve that approximates the transition of the point 102.

As previously mentioned, the vertical axis in FIG. 1 is on a logarithmic scale. Therefore, both the booking curve 104 and the cancellation curve 106 represent exponential functions. The inventors of the present invention have found that the number of bookings X(t) and the number of cancellations Y(t) at the accommodation facility are appropriately fitted to the following functional system by verification using actual data.

$$\begin{matrix}[ Equation 4 ] & \\ X ( t ) = {A}_{exp} ( - \frac{t}{{τ}_{X}} ) & ( Expression 2 )\end{matrix}$$

$$Y ( t ) = {B}_{exp} ( - \frac{t}{{τ}_{Y}} ) \qquad ( Expression 3 )$$

where A represents the number of bookings on the day when the service is provided, which is the accommodation date, and where B represents the number of cancellations on the day when the service is provided, which is the accommodation date.

The above results are converted into a prediction algorithm. The following statements are equivalent as information based on the fact that the above hypothesis is correct to a certain extent, the hypothesis being “the number of bookings decreases day by day in proportion to the number of days backward from the accommodation date, which is the distance from the accommodation date”.

“The number of bookings decreases day by day in proportion to the number of days backward from the accommodation date.”

“The number of bookings decreases exponentially as the date goes backward from the accommodation date.”

“The number of bookings increases exponentially toward the (future) accommodation date.”

Therefore, it can be found that Expression 2 above can be used to predict the number of bookings and that Expression 3 above can be used to predict the number of cancellations.

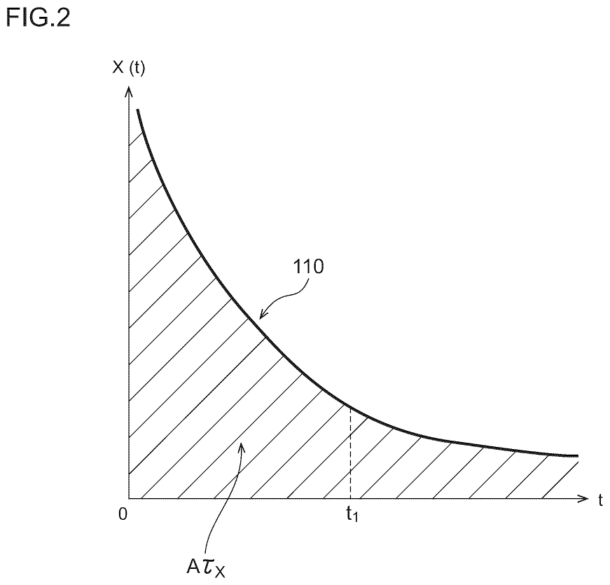

FIG. 2 schematically shows a booking curve. The horizontal axis in FIG. 2 represents the number of days t remaining until the date of service provision. The vertical axis in FIG. 2 is the number of service bookings X(t). The number of service bookings X(t) in FIG. 2 indicates the number of bookings that occur each day until the date of service provision. In FIG. 2, the vertical axis is shown on a normal scale. FIG. 2 shows a booking curve 110 derived through the estimation of the parameters A and τ_{X} in Expression 2 by fitting the number of bookings up to the time point t₁ (e.g., 30 days before) indicated by booking information to Expression 2 above. The total number of bookings up to the date of service provision, i.e., t=0, can be obtained by integrating X(t) with 0<t<∞ and is Aτ_{X}. The total number of bookings until the date of service provision can be estimated by finding Aτ_{X} in the booking curve 110.

### Outline of Present Embodiment

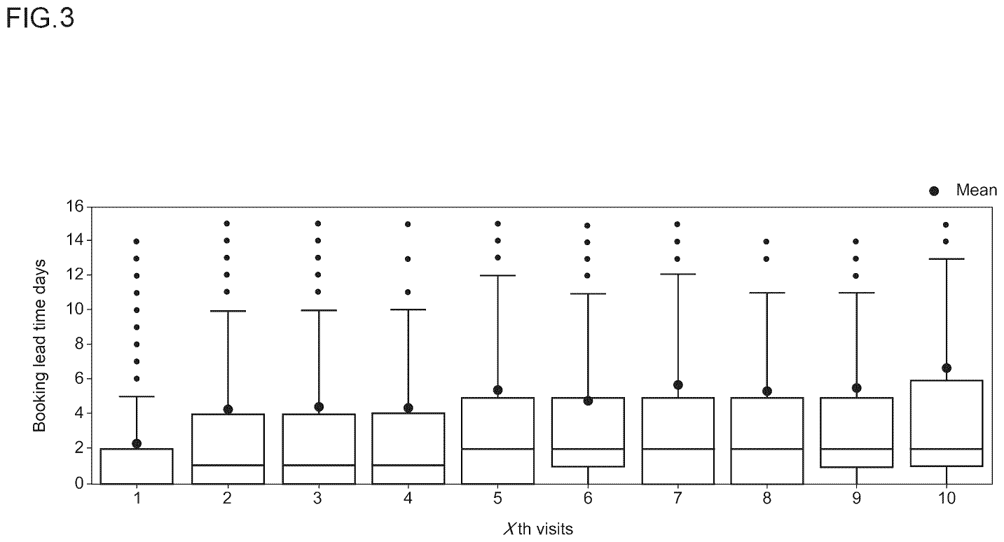

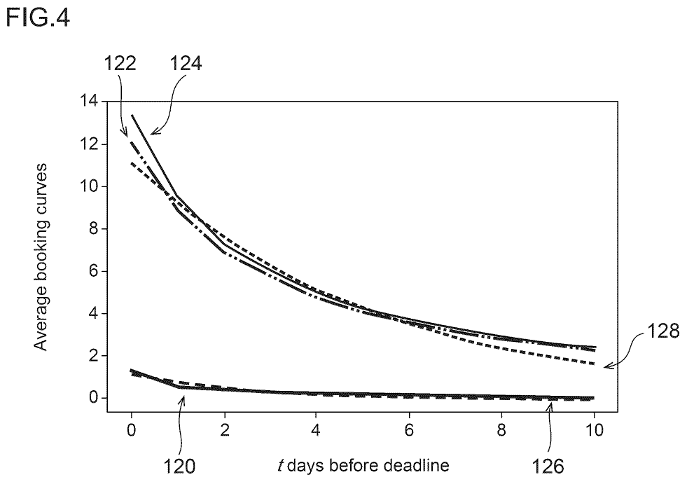

The inventors of the present invention have come to realize that that the slope of an exponential function, also referred to as a time constant, indicating the booking tendency of customers does not represent one slope for each unit of a service providing entity, also referred to as a facility, and varies according to the attributes of the customers. FIGS. 3 and 4 show specific examples thereof.

FIG. 3 is a diagram showing a box-and-whisker diagram showing the booking status of a beauty salon. The horizontal axis in FIG. 3 indicates the number of times a customer has visited the salon. Customers with a value of 1 on the horizontal axis are first-time users, and customers with a value of 2 or more on the horizontal axis are repeaters. The vertical axis in FIG. 3 indicates how many days before the visit the customer made a booking, i.e., booking lead time. The top boxes each indicate the range of 25 percent of bookings, and the bottom boxes also each indicate the range of 25 percent of bookings. This box-and-whisker diagram shows that bookings made by first-time customers are biased toward bookings made immediately before the service usage day as compared to repeat customers.

FIG. 4 shows the transition of the number of bookings at the beauty salon. The vertical axis in FIG. 4 indicates how many days before the date of service provision the booking was made, i.e., booking lead time. The vertical axis in FIG. 4 shows the number of bookings. A first-time user booking curve 120 (solid line) shows the transition of the number of bookings made by first-time users. A repeater booking curve 122 (solid line) shows the transition of the number of bookings made by repeaters. A total booking curve 124 (solid line) shows the sum of the number of bookings indicated by the first-time user booking curve 120 and the number of bookings indicated by the repeater booking curve 122.

A first-time user booking exponential curve 126 (dashed line) shows an exponential function curve that approximates the first-time user booking curve 120. A repeater booking exponential curve 128 (dashed line) shows an exponential function curve that approximates the repeater booking curve 122. The time constant t of the first-time user booking exponential curve 126 is about 2.2 days, while the time constant t of the repeater booking exponential curve 128 is about 5.2 days. Thus, the time constant of the repeater booking exponential curve 128 is about 2.5 times larger. This indicates that the slope of the first-time user booking exponential curve 126 is steeper than that of the repeater booking exponential curve 128, i.e., first-time user bookings account for a larger proportion of bookings made immediately before the date of service provision.

Based on such analysis results, the inventors of the present invention have come to realize that the booking tendency appears as an exponential function with a different time constant t for each customer attribute. Customer attributes mean, for example, high or low loyalty, which is a sense of belonging to the service provider, the facility, or the service itself. A system according to the embodiment derives an exponential function that approximates the booking tendency and that has a unique time constant t for each customer group with different attributes and estimates the transition of the number of bookings for each customer group. This supports the service provider to implement pricing measures with appropriate timing and appropriate contents for each customer group with different attributes.

An explanation will be given regarding an example of classifying customers based on their loyalty to the service provider, the facility, or the service itself. In this explanation, a customer group with relatively high loyalty is referred to as the first customer group, and a customer group with relatively low loyalty is referred to as the second customer group. As the first example, repeaters who have used the service at least once in the past may be classified into the first customer group, and first-time users of the service may be classified into the second customer group. As the second example, customers who have used the service N or more times may be classified into the first customer group, and customers who have used the service less than N times may be classified into the second customer group, where N is a natural number of 2 or more, for example, N=11.

As the third example, customers with low price sensitivity may be classified into the first customer group and customers with high price sensitivity may be classified into the second customer group. The price sensitivity may be the degree of responsiveness for the purchasing activity to changes in the service price. As the fourth example, customers who have already enrolled in a given loyalty or membership program may be classified into the first customer group, and customers who have not enrolled in the program may be classified into the second customer group. Based on the usage record, price sensitivity, and the like for the service, a plurality of customers may be classified into three or more customer groups, and an exponential function may be derived that indicates the booking tendency of each customer group.

The transition of the number of bookings in the embodiment is a time-series transition of the total number of bookings received from customers by the service provider. Canceled bookings will not be counted in the total number of bookings. Therefore, the transition of the number of bookings in the embodiment represents a monotonous increase. As an exemplary variation, the transition of the number of bookings may be a time-series transition of the number of bookings that occurs on a daily basis, as in the above mentioned Patent Literature 1. The total number of bookings is obtained by integrating the time-series transition of the number of bookings that occurs on a daily basis. Therefore, the booking tendency also appears as an exponential function with a time constant t different for each customer attribute in this exemplary variation.

The technology according to the embodiment can be applied to various types of demand prediction and specifically to the analysis of the number of bookings for services provided by various entities such as facilities, organizations, etc. Services to be analyzed include, for example, accommodation services provided by accommodation facilities, beauty services provided by beauty salons, and product sales services provided by retail stores. The technology is also applicable to the analysis of the number of bookings for platform services such as travel portal sites.

A detailed explanation will be given regarding embodiments in which the demand prediction algorithm explained above is used.

### First Embodiment

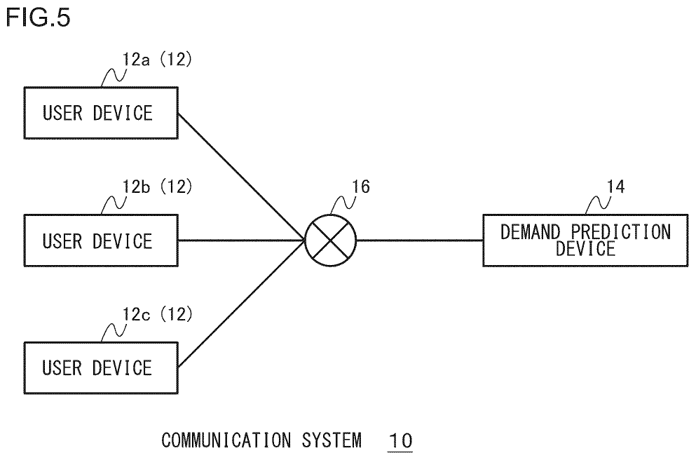

FIG. 5 shows the configuration of a communication system 10 according to the first embodiment. The communication system 10 includes user devices 12a, 12b, and 12c, which are collectively referred to as user devices 12, and a demand prediction device 14. The devices of the communication system 10 are connected via a communication network 16. The communication network 16 includes a publicly-known communication means such as LAN, WAN, and the Internet.

A user device 12 is an information processor used by a user of the demand prediction device 14. The user of the demand prediction device 14 is a provider of a predetermined service, e.g., accommodation service. For example, the user device 12a, the user device 12b, and the user device 12c may be used by a person in charge of a hotel A, a person in charge of a hotel B, and a person in charge of an inn C, respectively. Each user device 12 may be a PC, a smartphone, or a tablet terminal.

The demand prediction device 14 is an information processor that provides a demand prediction service using the demand prediction algorithm described above. The demand prediction device 14 may have a web server function and may provide a demand prediction service as a web application, in other words, a web service.

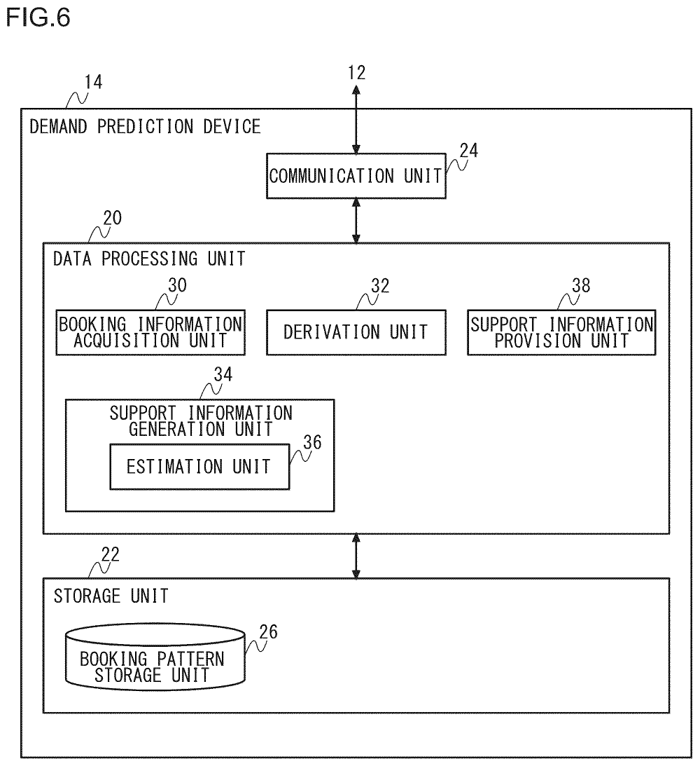

FIG. 6 is a block diagram showing functional blocks of a demand prediction device 14 according to the first embodiment. The functional blocks shown in the block diagrams of the present specification can be formed in hardware by a circuit block, a memory, other LSI's, or the like and can be accomplished in software by a program loaded in a memory, etc. Therefore, a person skilled in the art should appreciate that there are many ways of accomplishing these functional blocks in various forms in accordance with the components of hardware only, software only, or the combination of both, and the way of accomplishing these functions is not limited to any particular one.

The demand prediction device 14 includes a data processing unit 20, a storage unit 22, and a communication unit 24. A data processing unit 20 executes various data processing related to demand prediction. The storage unit 22 stores data that is referred to or updated by the data processing unit 20. The communication unit 24 communicates with external devices according to a predetermined communication protocol. The data processing unit 20 transmits and receives data to and from the user devices 12 via the communication unit 24.

The storage unit 22 includes a booking pattern storage unit 26. The booking pattern

storage unit 26 stores data related to a booking curve that shows a time-series transition of the number of bookings. The booking pattern storage unit 26 stores data related to a booking curve for each of a plurality of customer groups having different attributes from one another. The data processing unit 20 includes a booking information acquisition unit 30, a

derivation unit 32, a support information generation unit 34, and a support information provision unit 38. The functions of these multiple functional blocks may be implemented in a computer program, which is hereinafter referred to as “demand prediction program”. The demand prediction program may be installed in a storage of the demand prediction device 14 via a recording medium or a network. The processor, e.g., CPU, of the demand prediction device 14 may exert the functions of the multiple functional blocks by reading the demand prediction program into the main memory and running the demand prediction program.

The booking information acquisition unit 30 acquires first booking information indicating the time-series transition of the number of bookings up to the time point t1 prior to a service provision time point for the first customer group in the entity providing the predetermined service. The booking information acquisition unit 30 acquires second booking information indicating the time-series transition of the number of bookings up to the time point t2 prior to the service provision time point for the second customer group having an attribute different from that of the first customer group. The time point t1 and the time point t2 may be the same or different.

The derivation unit 32 derives a first exponential function indicating the time-series transition of the number of bookings up to the service provision time point for the first customer group based on the transition of the number of bookings up to the time point t1 for the first customer group indicated by the first booking information. Further, the derivation unit 32 derives a second exponential function indicating the time-series transition of the number of bookings up to the service provision time point for the second customer group based on the transition of the number of bookings up to the time point t2 for the second customer group indicated by the second booking information.

The first exponential function can be considered to be a booking curve indicating the booking tendency of the first customer group, and the second exponential function can be considered to be a booking curve indicating the booking tendency of the second customer group. The derivation unit 32 stores the data for the first exponential function in the booking pattern storage unit 26 in association with the data classified for the first customer group, and stores the data for the second exponential function in the booking pattern storage unit 26 in association with the data classified for the second customer group.

The support information generation unit 34 generates information for supporting the entity providing the service, hereinafter also referred to as “support information”, based on the time-series transition of the number of bookings up to an analysis target time point for the first customer group indicated by the first exponential function and the time-series transition of the number of bookings up to an analysis target time point for the second customer group indicated by the second exponential function. The analysis target time point may be the service provision time point, which is the date of service provision. The analysis target time point may be any time point specified by the user within a range later than time points t1 and t2 and earlier than the service provision time point, which is the date of service provision.

The support information generation unit 34 includes an estimation unit 36. The

estimation unit 36 performs an estimation process for the number of bookings based on the time-series transition of the number of bookings up to the analysis target time point for the first customer group indicated by the first exponential function and the time-series transition of the number of bookings up to the analysis target time point for the second customer group indicated by the second exponential function. The support information generation unit 34 generates support information based on the estimation result obtained by the estimation unit 36.

The support information provision unit 38 provides support information generated by the support information generation unit 34 to the user device 12. For example, the support information generation unit 34 generates support information for a user A based on an exponential function, a booking curve, derived based on booking information received from the user device 12a of the user A. In this case, the support information provision unit 38 transmits the support information for the user A to the user device 12a. Further, the support information generation unit 34 generates support information for a user B based on an exponential function, a booking curve, derived based on booking information received from the user device 12b of the user B. In this case, the support information provision unit 38 transmits the support information for the user B to the user device 12b.

The operation of the communication system 10 according to the first embodiment will now be explained. The user of the demand prediction device 14 in this case is a revenue manager of an accommodation facility. Further, the first customer group is a customer group whose loyalty to the service providing entity or the service itself is relatively high, and the group specifically consists of repeaters, repeating customers, who have stayed at the accommodation facility in the past. The second customer group is a customer group whose loyalty to the service providing entity or the service itself is relatively low, and the group specifically consists of first-time users who have never stayed at the accommodation facility in the past.

It is assumed that the user, the revenue manager, wants to know the booking status at an analysis target time point, hereinafter also referred to as “target date”. The target date in this case is a specific future date on which the accommodation service is to be provided. The user device 12 accesses the website provided by the demand prediction device 14 in response to a user operation. In response to the user operation, the user device 12 transmits to the demand prediction device 14 first booking information indicating the transition of the number of bookings for a stay on the target date received from the first customer group, the repeaters, up to the present time, e.g., t1 above. The first booking information may explicitly specify the target date and the time point t1.

In response to the user operation, the user device 12 transmits to the demand prediction device 14 second booking information indicating the transition of the number of bookings for a stay on the target date received from the second customer group, the first-time users, up to the present time, e.g., t2 above. The second booking information may explicitly specify the target date and the time point t2. As already mentioned, the transition of the number of bookings for a stay on a target date indicated by each of the first and second booking information is the transition of the total number of bookings counted daily in time series up to the present time, in other words, the transition of the sum of the number of bookings generated each day.

The booking information acquisition unit 30 of the demand prediction device 14 receives the first and second booking information transmitted from the user device 12a. The derivation unit 32 of the demand prediction device 14 derives a booking curve 110 for the first customer group as a first exponential function by estimating the parameters A and τₓ in Expression 2 by fitting the transition of the number of bookings up to the present time indicated by the first booking information to Expression 2 above. The booking curve 110 for the first customer group corresponds to the repeater booking exponential curve 128 in FIG. 4.

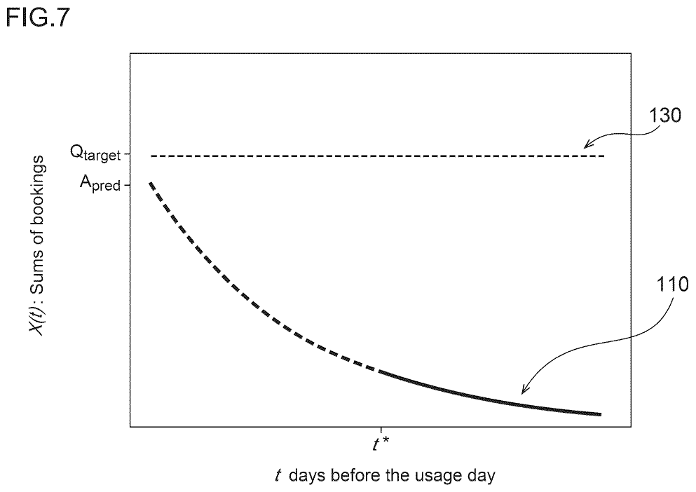

FIG. 7 shows an example of the booking curve for the first customer group. The horizontal axis in FIG. 7 indicates the number of days before the target date, and the vertical axis in FIG. 7 indicates the total number of bookings X(t). The total number of bookings X(t) can also be referred to as the cumulative number of bookings and is defined by Expression 2 above. The booking curve 110 according to the embodiment shows the time-series transition of the total number of bookings X(t) as a time-series transition of the number of bookings. As an exemplary variation, the booking curve 110 may be a graph showing the time-series transition of the number of bookings generated each day.

The solid-line portion of the booking curve 110 shows the transition of the total number of bookings received from the first customer group up to t1 as the actual values for stays on the target day. The dashed-line portion of the booking curve 110 shows the transition of the total number of bookings up to the target date as a prediction value for a stay on the target day. In FIG. 7, a first customer group target value 130, which indicates a predetermined target value for the number of bookings for the first customer group, is shown by a dashed line. The user device 12a may pre-register the first customer group target value 130 for its own facility to the demand prediction device 14 in response to an operation from the user, e.g., a revenue manager of the accommodation facility.

The derivation unit 32 derives a booking curve 110 for the second customer group as a second exponential function by estimating the parameters A and τₓ in Expression 2 by fitting the transition of the number of bookings for the target date up to the present time indicated by the second booking information to Expression 2 above. The booking curve 110 for the second customer group corresponds to the first-time user booking exponential curve 126 in FIG. 4.

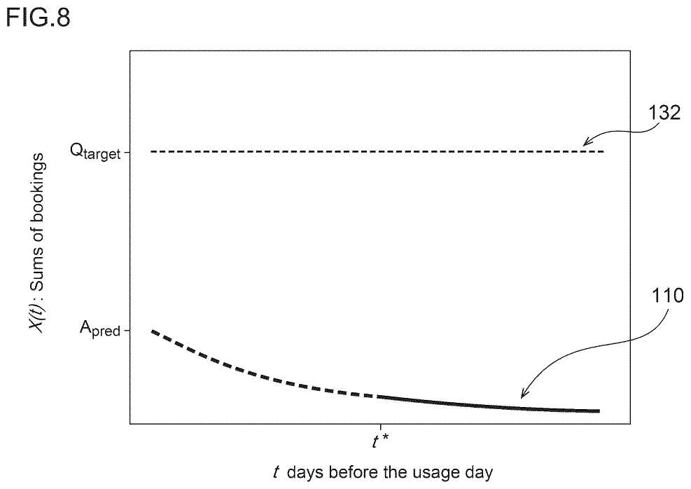

FIG. 8 shows an example of the booking curve 110 for the second customer group. The horizontal axis in FIG. 8 indicates the number of days before the target date, and the vertical axis in FIG. 8 indicates the total number of bookings X(t). The solid-line portion of the booking curve 110 shows the transition of the total number of bookings received from the second customer group up to t2 as the actual values for stays on the target day. The dashed-line portion of the booking curve 110 shows the transition of the total number of bookings up to the target date as a prediction value for a stay on the target day. In FIG. 8, a second customer group target value 132, which indicates a predetermined target value for the number of bookings for the second customer group, is shown by a dashed line. The user device 12a may pre-register the second customer group target value 132 for its own facility to the demand prediction device 14 in response to an operation from the user, e.g., a revenue manager of the accommodation facility.

The support information generation unit 34 of the demand prediction device 14 generates support information for the user based on the time-series transition of the number of bookings for the first customer group up to the target date indicated by the booking curve 110 for the first customer group and on the time-series transition of the number of bookings for the second customer group up to the target date indicated by the booking curve 110 for the second customer group. The support information in the first embodiment includes both the number of bookings for the first customer group at an analysis target time point, which is an estimated total number of bookings, and the number of bookings for the second customer group at an analysis target time point, which is an estimated total number of bookings. As an exemplary variation, the support information may include only one of the number of bookings for the first customer group at the analysis target time point, which is the estimated total number of bookings, and the number of bookings for the second customer group at the analysis target time point, which is the estimated total number of bookings if specified by the user, for example.

The support information provision unit 38 of the demand prediction device 14 transmits support information for the user to the user device 12, which is the user device 12a in this case. The user, a revenue manager of the accommodation facility in this case, adjusts, e.g., the price of an accommodation service for each customer group or the details of an accommodation plan for each customer group in reference to the support information.

The demand prediction device 14 according to the first embodiment derives an exponential function, which represents a booking curve 110, that indicates the time-series transition of bookings up to an analysis target time point for each customer group into which a plurality of customers have been classified at a service provider and that has a different attribute. Then, support information for the service provider is generated based on the exponential function, which represents the booking curve 110, for each customer group. This allows the accuracy of estimating the transition of the number of bookings for a service to be improved and useful support information to be provided based on highly accurate estimation results.

As explained in association with FIGS. 3 and 4, the characteristics, e.g., the time constant t, of a booking curve 110 are different for each customer group classified according to the level of loyalty to a service providing entity or a service. The demand prediction device 14 according to the first embodiment derives a booking curve 110 for each customer group classified according to the level of loyalty to a service providing entity or a service. This allows the accuracy of estimating the transition of the number of bookings for a service to be improved. Further, this can assist in setting appropriate prices and plans for each customer group with different levels of loyalty.

The demand prediction device 14 according to the first embodiment also provides the user with support information including at least one of an estimated total number of bookings for the first customer group at an analysis target time point and an estimated total number of bookings for the second customer group at the analysis target time point. This can help users adjust plans and prices for each customer group appropriately.

Described above is an explanation regarding the first embodiment of the present disclosure. The first embodiment is intended to be illustrative only, and it will be understood by those skilled in the art that various modifications to constituting elements and processes could be developed and that such modifications are also within the scope of the present disclosure.

The first exemplary variation with respect to the first embodiment will be explained now. In the first embodiment, customers whose loyalty to a service providing entity or a service itself is relatively high are classified into the first customer group, and customers whose loyalty to the service provider or the service itself is relatively low are classified into the second customer group. In an exemplary variation, customers who prefer services with relatively high profit for the service providing entity may be classified into the first customer group, and customers who prefer services with relatively low profit for the service providing entity may be classified into the second customer group. This exemplary variation can assist in setting appropriate prices and plans for each customer group that has a different level of influence on the profit for the service providing entity.

For example, it is assumed that there are two types of accommodation service plans; stays without meals; and stays with meals, and that stays with meals are more profitable for the accommodation facility. In this case, customers who are more likely to select a plan with meals may be classified into the first customer group, and customers who are more likely to select a plan without meals may be classified into the second customer group. Further, it is assumed that there are two types of accommodation bookings: accommodation bookings made using a regular accommodation booking website; and accommodation bookings made using a welfare website, and that accommodation bookings using a regular accommodation booking website are more profitable for the accommodation facility. In this case, customers who made accommodation bookings through a regular accommodation booking website may be classified into the first customer group, and customers who made accommodation bookings through a welfare website may be classified into the second customer group.

The second exemplary variation with respect to the first embodiment will be explained now. The derivation unit 32 of the demand prediction device 14 may derive a booking curve, hereinafter also referred to as “total booking curve”, that is a composite of multiple booking curves for multiple customer groups. A total booking curve can be considered to be a function in units of a facility or service to be analyzed that shows the time-series transition of the total number of bookings until the service provision time point.

If the customers of the facility or service to be analyzed are classified into the first and second customer groups, a total booking curve, which is a composite of a booking curve for the first customer group and a booking curve for the second customer group, is expressed by the following Expression 4.

$$\begin{matrix}[ Equation 5 ] & \\ X ( t ) = {A}_{1 exp} ( - \frac{t}{{τ}_{{X}_{1}}} ) + {A}_{2 exp} ( - \frac{t}{{τ}_{{X}_{2}}} ) & ( Expression 4 )\end{matrix}$$

X(t) represents the total number of bookings in units of facilities or services to be analyzed and is the sum of the total number of bookings for the first customer group and the total number of bookings for the second customer group. A1 represents the total number of bookings for the first customer group at an analysis target time point, e.g., a service provision date, and A₂ represents the total number of bookings for the second customer group at the analysis target time, e.g., a service provision date. τₓ₁ represents the time constant of a booking curve for the first customer group, and τₓ₂ represents the time constant of a booking curve for the second customer group.

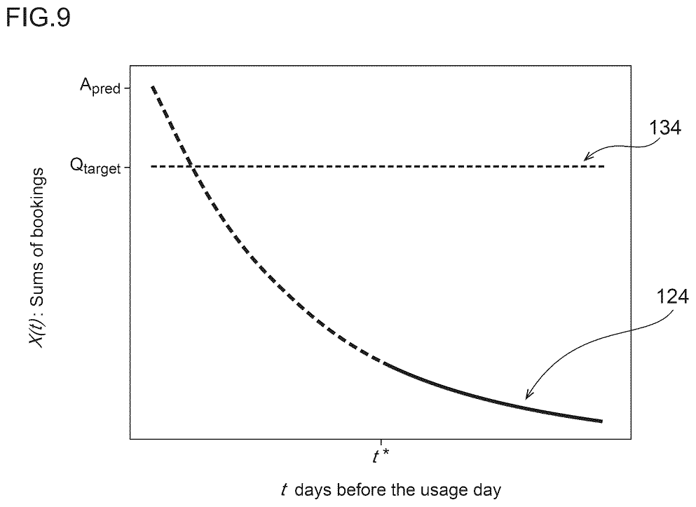

FIG. 9 shows an example of a total booking curve 124. The total booking curve 124 in FIG. 9 is the sum, in other words, a composite, of the booking curve 110 for the first customer group shown in FIG. 7 and the second customer group shown in FIG. 8. The horizontal axis in FIG. 9 indicates the number of days before the analysis target time point, e.g., the date of the service provision, and the vertical axis in FIG. 9 indicates the total number of bookings X(t). The solid-line portion of the total booking curve 124 shows the transition of the total number of bookings received from the first customer group and the second customer group up to t days prior to the analysis target time point as the actual values for the accommodation at the analysis target time point. The dashed portion of the total booking curve 124 shows the transition of the total number of bookings received from the first customer group and the second customer group up to the analysis target time point as predicted values for the accommodation on the target date.

In FIG. 9, a total booking target value 134, which indicates a predetermined target value for the total number of bookings for the first customer group and the second customer group, is shown by a dashed line. The user device 12 may pre-register the total booking target value 134 for its own facility to the demand prediction device 14 in response to an operation from the user, e.g., a revenue manager of the accommodation facility.

The support information generation unit 34 of the demand prediction device 14 may generate support information for the user based further on the time-series transition of the total number of bookings for the first and second customer groups up to the analysis target time point indicated by the total booking curve 124. For example, the support information generation unit 34 may determine whether the total number of bookings for the first customer group and the second customer group at the analysis target time point indicated by the total booking curve 124 has reached the total booking target value 134. If the total number of bookings for the first customer group and the second customer group at the analysis target time point has not reached the total booking target value 134, the support information generation unit 34 may generate support information including one or both of the total number of bookings for the first customer group at the analysis target time point indicated by the booking curve 110 for the first customer group and the total number of bookings for the second customer group at the analysis target time point indicated by the booking curve 110 for the second customer group, e.g., information on customer groups that have not reached the target.

The third exemplary variation with respect to the first embodiment will be explained now. The support information generation unit 34 of the demand prediction device 14 may generate support information including content that encourages to change, in other words, recommends to change at least one of the price of the service for the first customer group and the price of the service for the second customer group. This exemplary variation can assist the user to set appropriate prices for each customer group, in other words, allows for assisting in dynamic pricing for each customer group. Also, this exemplary variation can assist in the implementation of the overall optimal pricing policy. The following is specific examples of the third exemplary variation.

(Example 1) The estimation unit 36 determines whether the number of bookings for the first customer group at the analysis target time point achieves the first customer group target value 130 based on the booking curve 110 for the first customer group. If the number of bookings for the first customer group at the analysis target time point is estimated to achieve the first customer group target value 130, the support information generation unit 34 generates, as support information, information including content that encourages to increase the price for service provision to the second customer group to be higher than the previous price while maintaining the price for service provision to the first customer group.

According to the embodiment of Example 1, it is possible to encourage users to expand opportunities for highly loyal customers to purchase services and to assist users to take measures that place importance on highly loyal customers, repeaters, etc.

(Example 2) The estimation unit 36 determines whether the total of the number of bookings for the first customer group at the analysis target time point and the second customer group at the analysis target time point achieves the total booking target value 134 based on the total booking curve 124. If the sum of the number of bookings for the first customer group at the analysis target time point and the number of bookings for the second customer group at the analysis target time point is estimated to achieve the total booking target value 134, the support information generation unit 34 generates, as support information, information including content that encourages to increase the price for service provision to the first customer group by the first percentage and increase the price for service provision to the second customer group by the second percentage larger than the first percentage.

The above support information may include, for example, content that encourages to increase the price for service provision to the first customer group by 20 percent from the current 25,000 yen to 30,000 yen and to increase the price for service provision to the second customer group by 33% from the current 30,000 yen to 40,000 yen. According to the embodiment of Example 2, it is possible to assist users to properly control the number of bookings while favoring high-loyalty customers.

(Example 3) The estimation unit 36 determines whether the number of bookings for the first customer group at the analysis target time point achieves the first customer group target value 130 based on the booking curve 110 for the first customer group. Further, the estimation unit 36 determines whether the number of bookings for the second customer group at the analysis target time point achieves the second customer group target value 132 based on the booking curve 110 for the second customer group. If the number of bookings for the first customer group at the analysis target time point is estimated not to achieve the first customer group target value 130 and the number of bookings for the second customer group at the analysis target time point is estimated to achieve the second customer group target value 132, the support information generation unit 34 generates, as support information, information including content that encourages to decrease the price for service provision to the first customer group to be lower than the previous price and increase the price for service provision to the second customer group to be higher than the previous price.

According to the embodiment of Example 3, it is possible to encourage users to expand opportunities for highly loyal customers to purchase services and to assist users to take measures that place importance on highly loyal customers, repeaters, etc.

(Example 4) The estimation unit 36 determines whether the total of the number of bookings for the first customer group at the analysis target time point and the second customer group at the analysis target time point achieves the total booking target value 134 based on the total booking curve 124. If the sum of the number of bookings for the first customer group at the analysis target time point and the number of bookings for the second customer group at the analysis target time point is estimated to not achieve the total booking target value 134, the support information generation unit 34 generates, as support information, information including content that encourages to decrease the price for service provision to the second customer group to be lower than the previous price, e.g., by 50 percent, while maintaining the price for service provision to the first customer.

The embodiment of Example 4 can encourage users to expand opportunities to attract low-loyalty customers, e.g., first-time users, and can help improve loyalty across customers when the overall demand is low.

### Second Embodiment

The second embodiment will be explained focusing mainly on the differences from the first embodiment in the following, and explanations on common features will be omitted. The features of the second embodiment can be surely combined arbitrarily with the features of the first embodiment and the exemplary variations. Proposed in the second embodiment is a technology for adjusting the price of a service more directly according to the demand for the service.

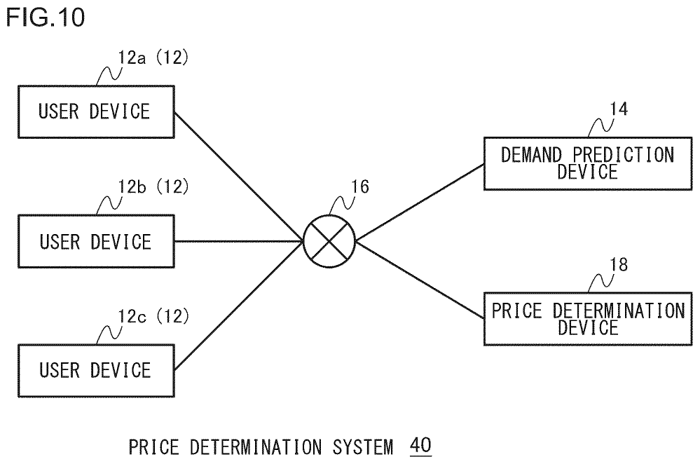

FIG. 10 shows the configuration of a price determination system 40 according to the second embodiment. The price determination system 40 includes a price determination device 18 in addition to the devices constituting the communication system 10 according to the first embodiment. The price determination device 18 is an information processor that determines or adjusts the price for service provision at each of a plurality of users. The price determination device 18 is connected to the user devices 12 and the demand prediction device 14 via the communication network 16. Although not shown, the price determination device 18 may be connected via the communication network 16 to a device for a website, e.g., a travel booking website, etc., that presents prices of services to customers.

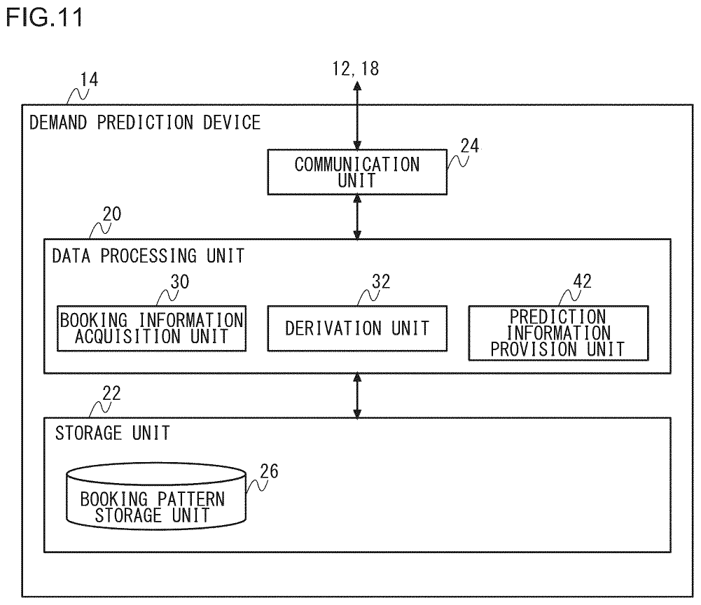

FIG. 11 is a block diagram showing functional blocks of a demand prediction device 14 according to the second embodiment. The demand prediction device 14 according to the second embodiment includes a prediction information provision unit 42 in addition to a booking information acquisition unit 30 and a derivation unit 32 of a demand prediction device 14 according to the first embodiment.

The prediction information provision unit 42 transmits prediction information that is based on the booking curve 110 for the first customer group derived by the derivation unit 32 and the booking curve 110 for the second customer group derived by the derivation unit 32 to the price determination device 18. The prediction information includes information indicating the time-series transition of the number of bookings up to the analysis target time point for the first customer group indicated by the booking curve 110 for the first customer group and information indicating the time-series transition of the number of bookings up to the analysis target time point for the second customer group indicated by the booking curve 110 for the second customer group. The prediction information further includes information indicating the time-series transition of the total number of bookings for the first customer group and the second customer group up to the analysis target time point indicated by the total booking curve 124, which is a composite of the booking curve 110 for the first customer group and the booking curve 110 for the second customer group.

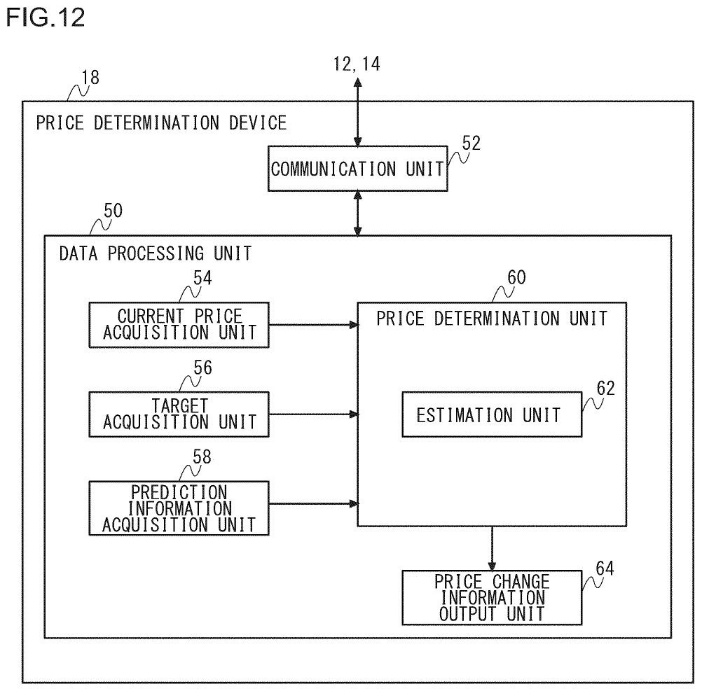

FIG. 12 is a block diagram showing functional blocks of a price determination device 18 according to the second embodiment. The price determination device 18 includes a data processing unit 50 and a communication unit 52. The data processing unit 50 executes data processing for determining or adjusting the price for service provision. The communication unit 52 communicates with an external device according to a predetermined communication protocol. The data processing unit 50 transmits and receives data to and from the user devices 12 and the demand prediction device 14 via the communication unit 52.

The data processing unit 50 includes a current price acquisition unit 54, a target acquisition unit 56, a prediction information acquisition unit 58, a price determination unit 60, and a price change information output unit 64. The functions of these multiple functional blocks may be implemented in a computer program, which is hereinafter referred to as “price determination program”. The price determination program may be installed in a storage of the price determination device 18 via a recording medium or a network. The processor, e.g., CPU, of the price determination device 18 may exert the functions of the multiple functional blocks by reading the price determination program into the main memory and running the price determination program.

The current price acquisition unit 54 acquires price information indicating a service provision price on a target date, which is an analysis target time point and is a service provision date in this case, currently being set by the service provider. The service provision price in this case is an amount paid by a customer who has booked the service provision for the target date, which is the accommodation price in the case of an accommodation service. The current price acquisition unit 54 may acquire the service provider's price information from the user device 12, the demand prediction device 14, or the system of a predetermined service booking site such as a travel booking portal site. The current price acquisition unit 54 passes the acquired price information to the price determination unit 60.

The target acquisition unit 56 acquires a target value, the first customer group target value 130, predetermined for the total number of bookings for the first customer group for the target date. Further, the target acquisition unit 56 acquires a target value, the second customer group target value 132, predetermined for the total number of bookings for the second customer group for the target date. The target acquisition unit 56 passes the first customer group target value 130 and the second customer group target value 132 to the price determination unit 60. The first customer group target value 130 and the second customer group target value 132 may be determined by the service provider.

If the service provider is an accommodation facility, the target acquisition unit 56 may acquire the number of rooms and the target occupancy rate for the target date from the user device 12, or the demand prediction device 14, and acquire the product of the two as a target value. The price determination device 18 may further include a target value storage unit that stores the first customer group target value 130 and the second customer group target value 132 for each service provider. The target value acquisition unit 74 may acquire the first customer group target value 130 and the second customer group target value 132 corresponding to the provider of the service subject to price determination from the target value storage unit.

The prediction information acquisition unit 58 acquires prediction information output from the demand prediction device 14. The prediction information acquisition unit 58 passes the prediction information to the price determination unit 60.

The price determination unit 60 determines the price for service provision subject to price determination based on the time-series transition of the number of bookings up to the target date for the first customer group indicated by the prediction information and time-series transition of the number of bookings up to the target date for the second customer group indicated by the prediction information. The price determination unit 60 determines or changes at least one of the price of the service for the first customer group and the price of the service for the second customer group. The price determination unit 60 passes price change information indicating the determined price for providing the service to the price change information output unit 64. The price change information output unit 64 transmits the price change information generated by the price determination unit 60 to an external device.

The price determination unit 60 includes an estimation unit 62. The estimation unit 62 corresponds to the estimation unit 36 of the demand prediction device 14 according to the first embodiment. The estimation unit 62 executes an estimation process for the number of bookings based on the time-series transition of the number of bookings up to the target date for the first customer group indicated by the prediction information and time-series transition of the number of bookings up to the target date for the second customer group indicated by the prediction information. The price determination unit 60 determines the price for service provision subject to price determination based on the estimation results from the estimation unit 62.

The operation of the price determination system 40 according to the second embodiment will now be explained. As in the first embodiment, the user of the demand prediction device 14 is a revenue manager of an accommodation facility, and it is assumed that the user, the revenue manager, wishes to have the price of the accommodation service adjusted automatically. The same operations are performed up to the derivation of the booking curve 110 for the first customer group and the booking curve 110 for the second customer group performed by the derivation unit 32 of the demand prediction device 14. Therefore, the explanation thereof is omitted.

The prediction information provision unit 42 of the demand prediction device 14 transmits prediction information that is based on the booking curve 110 for the first customer group and the booking curve 110 for the second customer group to the price determination device 18. The prediction information acquisition unit 58 of the price determination device 18 acquires the prediction information transmitted from the price determination device 18.

The user device 12 or the demand prediction device 14 transmits the first customer group target value 130 and the second customer group target value 132 predetermined by the user to the price determination device 18. The target acquisition unit 56 of the price determination device 18 acquires the first customer group target value 130 and the second customer group target value 132. Further, the current price acquisition unit 54 of the price determination device 18 acquires from the system of a travel booking site the price for service provision, each of the current price for the first customer group and the current price for the second customer group, at an accommodation facility subject to analysis for a target date.

The price determination unit 60 of the price determination device 18 determines one or both of a new price for the first customer group and a new price for the second customer group based on the prediction information, the first customer group target value 130, the second customer group target value 132, the current price for the first customer group, and the current price for the second customer group. The price change information output unit 64 of the price determination device 18 transmits price change information indicating one or both of the new price for the first customer group and the new price for the second customer group to the system of the travel booking site. This updates one or both of the price for the first customer group and the price for the second customer group at the accommodation facility subject to analysis that is presented to a customer at the travel booking site.

The following are examples of price determination performed by the price determination device 18.

(Example 1) The estimation unit 62 determines whether the number of bookings for the first customer group at the analysis target time point achieves the first customer group target value 130 based on the time-series transition of the number of bookings up to the analysis target time point for the first customer group indicated by the prediction information. If the number of bookings for the first customer group at the analysis target time point is estimated to achieve the first customer group target value 130, the price determination unit 60 determines to increase the price for service provision to the second customer group to be higher than the previous price while maintaining the price for service provision to the first customer group.

According to the embodiment of Example 1, it is possible to encourage users to expand opportunities for highly loyal customers to purchase services and to assist users to take measures that place importance on highly loyal customers, repeaters, etc.

(Example 2) The estimation unit 62 determines whether the total of the number of bookings for the first customer group at the analysis target time point and the second customer group at the analysis target time point achieves the total booking target value 134 based on the prediction information. If the sum of the number of bookings for the first customer group at the analysis target time point and the number of bookings for the second customer group at the analysis target time point is estimated to achieve the total booking target value 134, the price determination unit 60 determines to increase the price for service provision to the first customer group by the first percentage and increase the price for service provision to the second customer group by the second percentage larger than the first percentage.

For example, the price determination unit 60 may determine to increase the price for service provision to the first customer group by 20 percent from the current 25,000 yen to 30,000 yen and to increase the price for service provision to the second customer group by 33% from the current 30,000 yen to 40,000 yen. According to the embodiment of Example 2, it is possible to assist users to properly control the number of bookings while favoring high-loyalty customers.

(Example 3) The estimation unit 62 determines whether the number of bookings for the first customer group at the analysis target time point achieves the first customer group target value 130 based on the prediction information. Further, the estimation unit 62 determines whether the number of bookings for the second customer group at the analysis target time point achieves the second customer group target value 132 based on the prediction information. If the number of bookings for the first customer group at the analysis target time point is estimated not to achieve the first customer group target value 130 and the number of bookings for the second customer group at the analysis target time point is estimated to achieve the second customer group target value 132, the price determination unit 60 determines to decrease the price for service provision to the first customer group to be lower than the previous price and increase the price for service provision to the second customer group to be higher than the previous price.

According to the embodiment of Example 3, it is possible to encourage users to expand opportunities for highly loyal customers to purchase services and to assist users to take measures that place importance on highly loyal customers, repeaters, etc.

(Example 4) The estimation unit 62 determines whether the total of the number of bookings for the first customer group at the analysis target time point and the second customer group at the analysis target time point achieves the total booking target value 134 based on the prediction information. If the sum of the number of bookings for the first customer group at the analysis target time point and the number of bookings for the second customer group at the analysis target time point is estimated to not achieve the total booking target value 134, the price determination unit 60 determines to decrease the price for service provision to the second customer group to be lower than the previous price, e.g., by 50 percent, while maintaining the price for service provision to the first customer.

The embodiment of Example 4 can encourage users to expand opportunities to attract low-loyalty customers, e.g., first-time users, and can help improve loyalty across customers when the overall demand is low.

A reduction value for the case of lowering the price for service provision and an increase value for the case of increasing the price for service provision may be predetermined by each service provider and registered in the price determination device 18. The reduction and increase values may be determined for each customer group. In this case, the price determination device 18 may further include an adjustment data storage unit that stores reduction and increase values for each service provider. The price determination unit 60 may adjust one or both of the price for service provision for the first customer group and the price for service provision for the second customer group based on the current price for the first customer group and the current price for the second customer group acquired by the current price acquisition unit 54.

According to the price determination system 40 of the second embodiment, the price determination device 18 automatically adjusts the price for service provision subjected to analysis by the demand prediction device 14 based on the prediction information from the demand prediction device 14. This allows for reduction in the burden on the service provider, e.g., a revenue manager of an accommodation facility. Further, appropriate price setting for each customer group can be supported, in other words, dynamic pricing for each customer group can be supported.

The present disclosure is further characterized by a computer-implemented system for adjusting operational parameters using the time constant τ as a quantitative metric to represent the lead time between booking and corresponding event dates. A smaller time constant, for example, indicates casual and price-sensitive customers who tend to book closer to the event date, whereas a larger time constant suggests early planners or less price-sensitive customers. To operationalize this metric, the information processor defines one or more threshold values-such as low, medium, and high time constant ranges-based on historical booking behavior patterns, industry benchmarks, or customized business rules.

For instance, the information processor may establish a low-threshold τ₁ (e.g., τ<2 days) to identify high-likelihood last-minute bookings, a medium-range tτₘ (e.g., 2 days≤τ<7 days) to represent average booking windows, and a high-threshold τₕ (e.g., τ≥7 days) to capture early reservations.

These thresholds can be adjusted dynamically over time using machine learning models that track changes in customer behavior or seasonal trends. When the current time constant τ falls below, within, or above these thresholds, corresponding operational responses are triggered. For example: If τ<τ₁, indicating last-minute behavior, the information processor signals increase in digital ad impressions, offer flash promotions, or adjust staffing to accommodate potential surges. If τ falls within τ₂, routine scheduling and pricing strategies may apply. If τ>τ₃, indicating early interest, the information processor may allocate more premium inventory or reduce promotional spending for that time slot. By continuously comparing τ against these adaptive thresholds, the information processor enables real-time optimization of operational parameters, such as staff scheduling, inventory allocation, promotional campaign, and dynamic pricing, thereby improving overall efficiency and customer satisfaction.

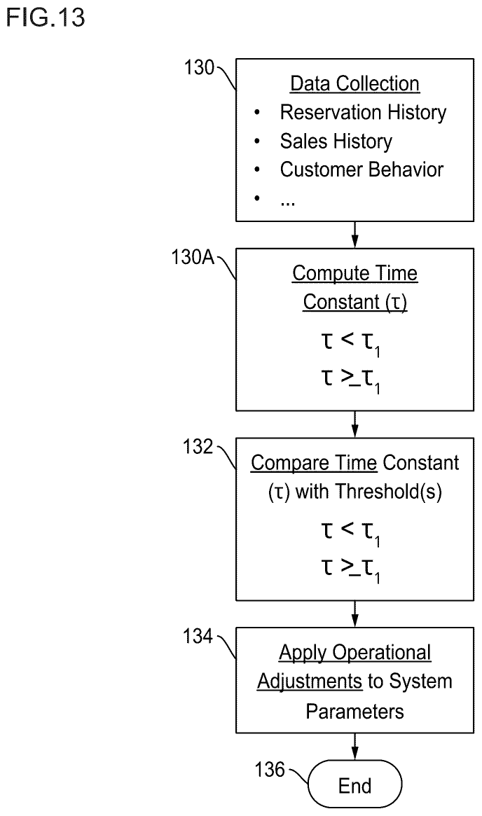

FIG. 13 illustrates an exemplary process for performing system parameter adjustment based on time constant analysis derived from customer data. The process may be implemented in a computing system that includes one or more processors, memory, and a database for storing historical transaction and reservation data. The process begins at step 130, in which the system performs data collection from various sources. Such data may include, for example, reservation history, sales history, customer behavior data and etc. Additional data types may also be incorporated as needed to improve the accuracy of subsequent computations. The collected data is stored in memory or a database and may optionally be preprocessed to remove noise, normalize time intervals, and aggregate relevant metrics prior to subsequent computation.

At step 130A, the system computes a time constant (τ) that characterizes the dynamic behavior of the system. In some implementations, τ may represent the rate at which reservations, sales, or customer engagement decays over time following an operational change or promotional event. In other implementations, τ may be determined based on the slope of a demand curve, the response time of sales to price adjustments, or other temporal features derived from the collected data. For example, τ may be computed using: (1) an exponential decay model applied to historical sales or reservation activity to estimate how quickly demand decreases; (2) a moving average or weighted time series model to capture short term and long term demand responsiveness; or (3) a machine learning model, such as a regression or predictive model trained to infer system response characteristics under varying operational conditions.

At step 132, the computed time constant (τ) is compared with one or more threshold values (τ₁, τ₂, . . . ) that define operational decision boundaries. For instance, a single threshold τ₁ may be used to classify the system behavior into two modes as follows: (1) t<τ₁: indicating that the system or demand is highly responsive or unstable, warranting proactive operational intervention; and (2) τ≥τ₁: indicating that the system is stable or less responsive, allowing normal operations to continue without immediate adjustment. In more complex embodiments, multiple thresholds may define graduated operational states, enabling tiered responses. The thresholds may be predefined, dynamically learned from historical data, or adaptively tuned over time. At step 134, based on the comparison result, the system applies operational adjustments to system parameters. Such adjustments may include: (a) inventory control actions, such as increasing or decreasing stock levels, reordering products, or reprioritizing fulfillment schedules; (b) reservation and scheduling modifications, including updating booking limits, shifting reservation windows, or modifying overbooking tolerances; (c) staffing and resource allocation adjustments, such as increasing personnel during high responsiveness periods or reducing staff in stable demand periods; and (d) pricing or promotion actions, including dynamic pricing changes or targeted discounts to stimulate demand or manage supply. These adjustments can be applied automatically, semi automatically with operator approval, or triggered as recommendations for manual implementation.

The process concludes at step 136, after operational adjustments have been applied. The system may log the changes and their corresponding impact for future feedback and recalibration of the time constant computation. This closed loop process allows the system to continuously monitor, predict, and respond to changes in customer behavior, optimizing operational efficiency and resource utilization in real time.

In certain implementations, the time constant can be determined using the time-rescaling regression method proposed by Shintani and Umeno (2022), which provides a robust, lightweight approach to exponential fitting for decay-type time series predictions, even in the presence of sparse or noisy data.

Described above is an explanation regarding the exemplary embodiments of the present disclosure. The exemplary embodiments are intended to be illustrative only, and it will be understood by those skilled in the art that various modifications to constituting elements and processes could be developed and that such modifications are also within the scope of the present disclosure.

The physical number of devices is not limited for each of the respective devices according to the first embodiment and the second embodiment. For example, the functions of the respective demand prediction devices 14 according to the first and second embodiments may be implemented in multiple information processors in a distributed manner. These information processors may communicate with one another and cooperate as a system so as to thereby perform the functions of the demand prediction devices 14 of the respective embodiments. Similarly, the functions of the price determination device 18 according to the second embodiment may be implemented in multiple information processors in a distributed manner. These information processors may communicate with one another and cooperate as a system so as to thereby perform the functions of the price determination device 18. A computer program in which at least one of the functions of the demand prediction device 14 and the functions of the price determination device 18 is implemented may be installed in a user device 12. In this case, the user device 12 may perform at least one of the functions of the demand prediction device 14 and the functions of the price determination device 18.

Optional combinations of the aforementioned embodiments and exemplary variations will also be within the scope of the present disclosure. New embodiments resulting from the combinations will provide the advantages of the embodiment and the exemplary variations combined. It will be obvious to those skilled in the art that the function to be achieved by each constituent requirement described in the claims are achieved by each constituting element shown in the embodiments and in the exemplary variations or by a combination of the constituting elements.

What is claimed is:

1. An information processor of a demand prediction device, the information processor comprising:
an acquisition unit that is configured to acquire time-series transition of the number of bookings up to a time point t1 prior to a service provision time point for a first customer group in an entity providing a predetermined service and acquires time-series transition of the number of bookings up to a time point t2 prior to a service provision time point for a second customer group different from the first customer group;
a derivation unit that is configured to derive a first exponential function indicating the time-series transition of the number of bookings up to the service provision time point for the first customer group based on the transition of the number of bookings up to the time point t1 for the first customer group and derives a second exponential function indicating the time-series transition of the number of bookings up to the service provision time point for the second customer group based on the transition of the number of bookings up to the time point t2 for the second customer group;
a processing unit for computing a time constant from an exponential fit of cumulative reservations
and
a generation unit that is configured to generate an estimated total number of bookings for supporting the entity based on the time-series transition of the number of bookings up to an analysis target time point for the first customer group indicated by the first exponential function and the time-series transition of the number of bookings up to the analysis target time point for the second customer group indicated by the second exponential function,
wherein the generation unit also is configured to generate electronic content directed to an increase or a decrease in a price for the predetermined service based on the estimated total number of bookings and a target value for the entity, wherein the generation unit generates information as part of the electronic content using at least one of the price of the service for the first customer group and the price of the service for the second customer group, and wherein the first customer group is a customer group with a higher loyalty to the entity or service based on captured first customer attributes than the second customer group, and the second customer group is a customer group with a lower loyalty to the entity or service based on captured second customer attributes,
wherein the generation unit generates as the information part of the electronic content, additional electronic content to adjust at least one of the price of the service for the first customer group based on the higher loyalty based on the captured first customer attributes and the price of the service for the second customer group based on the lower loyalty based on the captured second customer attributes,
wherein the price of the service for the first customer group differs from the price of the second customer group after the adjustment, and
wherein the time constant is compared with at least one threshold value to determine a system response, which triggers an adjustment to one or more operational parameters.

2. The information processor according to claim 1, wherein
the first customer group is a customer group with a higher loyalty to the entity or the service than the second customer group, and the second customer group is a customer group with a lower loyalty to the entity or the service than the first customer group.

3. The information processor according to claim 1, wherein
the first customer group is a customer group who prefers services with a higher profit for the entity than the second customer group, and the second customer group is a customer group who prefers services with a lower profit for the entity than the first customer group.

4. The information processor according to claim 1, wherein
the generation unit generates information including at least one of the number of bookings for the first customer group at the analysis target time point and the number of bookings for the second customer group at the analysis target time point as information for supporting the entity.

5. The information processor according to claim 1, wherein the adjustment to the operational parameters comprises at least one of modifying inventory levels, adjusting reservation or scheduling limits, reallocating staffing or system resources, and updating pricing or promotional parameters.

6. The information processor according to claim 1, wherein
the generation unit generates information for the additional electronic content to increase the price for the service for the second customer group while maintaining the price for the service for the first customer group if the number of bookings for the first customer group at the analysis target time point is estimated to achieve the target value.

7. The information processor according to claim 1, wherein
the generation unit generates information for the additional electronic content to increase the price for the service for the first customer group by a first percentage and increase the price for the service for the second customer group by a second percentage larger than the first percentage if the sum of the number of bookings for the first customer group at the analysis target time point and the number of bookings for the second customer group at the analysis target time point is estimated to achieve the target value.

8. The information processor according to claim 1, wherein
the generation unit generates information for the additional electronic content to lower the price for the service for the first customer group and raise the price for the service for the second customer group if the number of bookings for the first customer group at the analysis target time point is estimated to not achieve a target while the number of bookings for the second customer group at the analysis target time point is estimated to achieve the target value.
